(19) United States
(12) Patent Application Publication
(10) Pub. No.: US 2026/0285345 A1
(43) Pub. Date: Sep. 24, 2026

(54) IN-VEHICLE SYSTEM AND STORAGE MEDIUM

(71) Applicant: SONY HONDA MOBILITY INC., Tokyo (JP)

(72) Inventors: Junichi NAGAHARA, Tokyo (JP); Yukinori Taniuchi, Tokyo (JP); Shuichi Ono, Tokyo (JP); Yasuhisa Ito, Tokyo (JP); Toshihiro Hirao, Tokyo (JP)

(73) Assignee: SONY HONDA MOBILITY INC., Tokyo (JP)

(21) Appl. No.: 19/087,626

(22) Filed: Mar. 24, 2025

(51) Int. Cl. B60W 50/14; B60W 50/00; H04S 7/00

(52) U.S. Cl. CPC B60W 50/14; B60W 50/0097; H04S 7/30; B60W 2540/18

(57) ABSTRACT

To enable appropriate information to be presented to a driver using a pseudo powertrain sound. An in-vehicle system according to an aspect of the present technique acquires control information used to control each wheel and changes a sound source position of a pseudo powertrain sound to be outputted in a vehicle according to the control information. The present technique can be applied to electric vehicles including a function to output pseudo powertrain sounds.

### BACKGROUND OF THE INVENTION

### Field of the Invention

The present technique relates to an in-vehicle system and a storage medium and, particularly, to an in-vehicle system and a storage medium that enable appropriate information to be presented to a driver using a pseudo powertrain sound.

### Description of the Related Art

In electric vehicles that produce no engine sound while traveling, there are techniques to generate a pseudo engine sound based on accelerator position, velocity, and the like. Outputting a pseudo engine sound toward the inside of a vehicle enables a sensation similar to that of driving a vehicle mounted with an engine to be imparted to the driver (see, for example, Japanese Laid-Open Patent Publication No. 2000-1142 A, International Publication No. WO 2011/092833 A1, and U.S. Pat. No. 11,919,446 B2).

Contents to be presented to the driver by conventional pseudo engine sounds that change according to an accelerator position and a velocity are limited to information such as the accelerator position and the velocity.

The present technique has been devised in consideration of such circumstances and an object thereof is to enable appropriate information to be presented to a driver using a pseudo powertrain sound.

Note that the description of the problem given above does not preclude the existence of other problems.

### SUMMARY OF THE INVENTION

An in-vehicle system according to an aspect of the present technique includes an acquiring unit that acquires control information used to control each wheel; and an acoustic control unit that changes a sound source position of a pseudo powertrain sound to be outputted in a vehicle according to the control information.

In the aspect of the present technique, control information used to control each wheel is acquired and a sound source position of a pseudo powertrain sound is outputted in the vehicle changes according to the control information.

According to the present technique, appropriate information can be presented to a driver using a pseudo powertrain sound.

### BRIEF DESCRIPTION OF THE DRAWINGS

FIG. 1 is a diagram showing an example of a sound source position of a pseudo powertrain sound;

FIG. 2 is a view of a driver's seat area from above;

FIG. 3 is a diagram showing an example of a vehicle swept path of a vehicle;

FIG. 4 is a diagram showing an example of a determination method of a deviation of a vehicle swept path;

FIG. 5 is a diagram showing an example of a presentation method of a pseudo powertrain sound;

FIG. 6 is a diagram showing an example of adjustment of a sound source position;

FIG. 7 is a diagram showing an example of a change in sounds that constitute a pseudo powertrain sound;

FIG. 8 is a diagram showing an example of a change in sounds that constitute a pseudo powertrain sound;

FIG. 9 is a diagram showing an example of deceleration of a vehicle;

FIG. 10 is a diagram showing an example of a determination method of a deviation of velocity;

FIG. 11 is a diagram showing an example of a sound source position;

FIG. 12 is a diagram showing a direction of movement of a sound source position;

FIG. 13 is a diagram showing an example of vehicle stabilization by a skid prevention function;

FIG. 14 is a diagram showing an example of adjustment of a sound source position;

FIG. 15 is a block diagram showing a configuration example of an in-vehicle system;

FIG. 16 is a block diagram showing a functional configuration example of the in-vehicle system;

FIG. 17 is a flow chart showing an example of processing of the entire in-vehicle system;

FIG. 18 is a diagram showing an example of vehicle swept path reflection processing that is performed in step S2 in FIG. 17;

FIG. 19 is a diagram showing an example of acceleration reflection processing that is performed in step S4 in FIG. 17; and

FIG. 20 is a diagram showing an example of control information reflection processing that is performed in step S6 in FIG. 17.

### DETAILED DESCRIPTION OF THE INVENTION

Hereinafter, modes for carrying out the present technique will be described. The description will be given in the following order.
1. Outline of present technique
2. Change in sound source position according to vehicle swept path
3. Change in sound source position according to velocity
4. Change in sound source position according to acceleration
5. Change in sound source position using control information of vehicle stabilization system
6. Configuration example of in-vehicle system
7. Operation of in-vehicle system
8. Modifications

### Outline of Present Technique

The present technique relates to a technique of changing a sound source position of a pseudo powertrain sound that is outputted in a vehicle according to a travel state. The present technique is applied to, for example, electric vehicles. A driver of an electric vehicle mounted with an in-vehicle system according to an embodiment of the present technique is to drive while listening to the pseudo powertrain sound of which the sound source position changes.

The pseudo powertrain sound is a produced sound that simulates the sound of a powertrain such as an engine or a motor. The sound source position of the pseudo powertrain sound that changes according to acceleration/deceleration or the like changes according to a travel state. The pseudo powertrain sound may contain various sounds used for production during travel such as a brake noise or a wind noise.

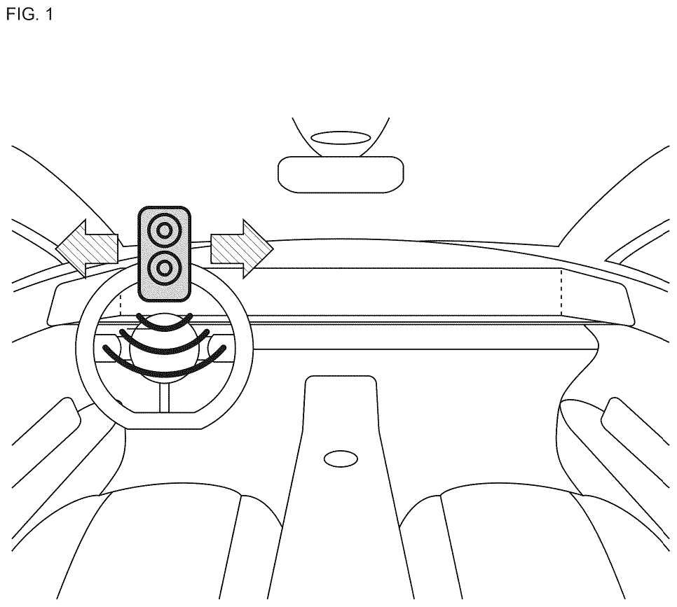

FIG. 1 is a diagram showing an example of a sound source position of a pseudo powertrain sound. FIG. 1 shows a driver's seat area in a vehicle.

A plurality of speakers are provided in the vehicle. During travel, the sound source position of the pseudo powertrain sound is changed by adjusting a volume or the like of sound outputted from each speaker. The output of the pseudo powertrain sound is realized using, for example, object-based audio. An in-vehicle system is provided with a reproduction function of object-based audio that outputs a reproduced sound from any position by setting a sound source at any position in the vehicle and performing rendering processing of audio data according to the sound source position.

In FIG. 1, a speaker shown above a seat surface of the driver's seat indicates a sound source of the pseudo powertrain sound. A colored speaker in FIG. 1 indicates that a virtual sound source is set at a position of the speaker.

As indicated by an arrow in FIG. 1, the sound source position of the pseudo powertrain sound moves in a lateral direction (left-right direction with respect to a travel direction). As will be described later, for example, the sound source position moves in the lateral direction according to a difference between a target vehicle swept path and an actual vehicle swept path. A travel state used to adjust the sound source position includes a vehicle swept path of the vehicle.

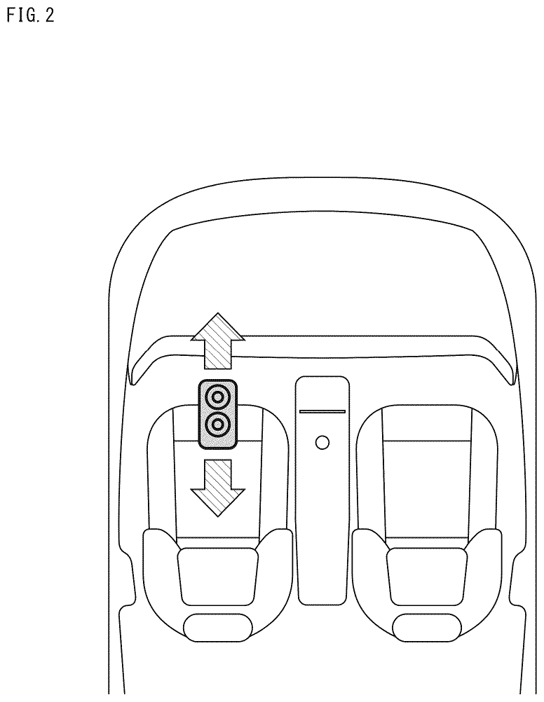

FIG. 2 is a view of a driver's seat area from above. Upward in FIG. 2 corresponds to the front of the vehicle.

As indicated by an arrow in FIG. 2, the sound source position of the pseudo powertrain sound also moves in a front-rear direction. As will be described later, for example, the sound source position moves in the front-rear direction according to a difference between a target velocity and an actual velocity. A travel state used to adjust the sound source position includes a velocity of the vehicle.

A function of guiding the travel state of the vehicle to an ideal state is realized by changing the sound source position of the pseudo powertrain sound according to a difference between the target travel state and the actual travel state.

A state of traveling on a same vehicle swept path as the vehicle swept path set by the in-vehicle system is an ideal state. In addition, a state of traveling at a same velocity as the velocity set by the in-vehicle system is an ideal state. By being aware of the sound source position of the pseudo powertrain sound, the driver can perform driving operations to approach the ideal states. Using pseudo engine sounds, the in-vehicle system can provide information that can improve the driver's safety awareness and driving skills.

### Change in Sound Source Position According to Vehicle Swept Path

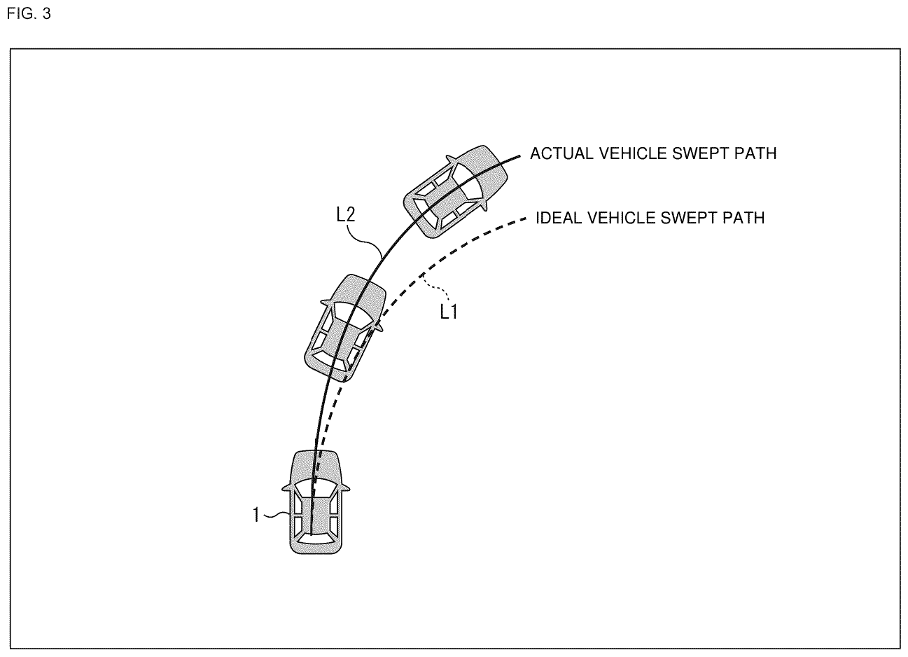

FIG. 3 is a diagram showing an example of a vehicle swept path of a vehicle. FIG. 3 shows a vehicle swept path of a vehicle 1 mounted with the in-vehicle system according to an embodiment of the present technique.

A vehicle swept path depicted by a dashed line L1 is a target vehicle swept path. The target vehicle swept path is a vehicle swept path to be a target. For example, a vehicle swept path that passes through a center of a driving lane is set as the target vehicle swept path. As indicated by a solid line L2, when an actual vehicle swept path deviates toward the left with respect to the target vehicle swept path, the sound source position of the pseudo powertrain sound is set so as to be heard from the right. For example, the sound source position is set at a position moved to the right with a position of the driver's seat as a reference position.

Conversely, when the actual vehicle swept path deviates toward the right with respect to the target vehicle swept path, the sound source position of the pseudo powertrain sound is set so as to be heard from the left. The sound source position is set at a position moved to the left with a position of the driver's seat as a reference position.

For example, an amount of movement of the sound source position changes according to a difference in the lateral direction between the target vehicle swept path and the actual vehicle swept path. The larger the difference in the lateral direction between the target vehicle swept path and the actual vehicle swept path, the larger the amount of movement of the sound source position from the reference position.

By moving the sound source position of the pseudo powertrain sound in the lateral direction in this manner, the driver is to hear the pseudo powertrain sound outputted from the direction of the target vehicle swept path. The driver can intuitively know the direction of the target vehicle swept path. In addition, due to a change in the amount of movement of the sound source position, the driver can intuitively know how much the vehicle swept path according to the driver's own driving operations relatively deviates from the target vehicle swept path.

When traveling along the same vehicle swept path as the target vehicle swept path, the sound source position of the pseudo powertrain sound is set to the reference position. The driver can intuitively know that he/she is able to travel along the same vehicle swept path as the target vehicle swept path by confirming that he/she can hear the pseudo powertrain sound from nearby.

Although it has been described that the sound source position to be a reference of the pseudo powertrain sound is the driver's seat position in the present example, the sound source position may also be a position on a central axis of the vehicle 1. In a state where the vehicle 1 is viewed from above as shown in FIG. 3, an axis that passes through a center of the vehicle 1 in a width direction is the central axis of the vehicle 1. In this case, the reference position is a position slightly deviated to the right from the position of the driver's seat provided at, for example, the left seat of the vehicle 1. A state where the pseudo powertrain sound is heard from a position slightly deviated to the right is the state where the vehicle is traveling on the same vehicle swept path as the target vehicle swept path.

The sound source position may be moved to the left when the actual vehicle swept path is deviated to the left and the sound source position may be moved to the right when the actual vehicle swept path is deviated to the right. A direction of movement of the sound source position may be opposite to or in the same direction as the direction of deviation of the actual vehicle swept path with respect to the target vehicle swept path.

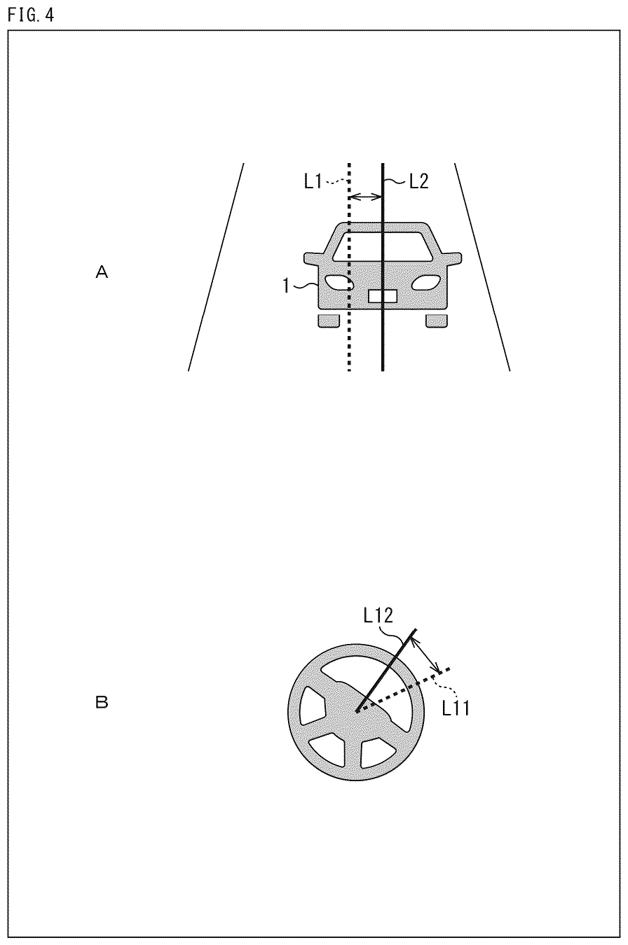

FIG. 4 is a diagram showing an example of a determination method of a deviation of a vehicle swept path.

The in-vehicle system is mounted with a driving automation system. Driving automation functions that are functions of the driving automation system at least include functions of AD (automated driving) and functions of ADAS (advanced driver-assistance systems).

The target vehicle swept path is set by a travel plan created by the driving automation function. The actual vehicle swept path is obtained based on, for example, a result of measurement by a sensor provided at each position in the vehicle 1. The vehicle 1 is provided with a positioning sensor that receives a signal from a GNSS (global navigation satellite system) satellite and performs positioning. The vehicle 1 is also provided with various sensors to be used to measure the travel environment such as a camera, a radar, LiDAR (light detection and ranging), and an ultrasonic sensor.

A in FIG. 4 represents a determination method using a target vehicle swept path set according to a travel plan created by the driving automation function and an actual vehicle swept path obtained based on a measurement result of the sensors. The sound source position of the pseudo powertrain sound is adjusted according to a difference in the lateral direction between the target vehicle swept path depicted by the dashed line L1 and the actual vehicle swept path depicted by the solid line L2.

B in FIG. 4 represents a determination method using a target steering angle and an actual steering angle. For example, the target steering angle of a steering wheel at each timing is determined according to the setting of the target vehicle swept path based on the travel plan created by the driving automation function. The sound source position of the pseudo powertrain sound is adjusted according to a difference between the target steering angle depicted by a dashed line L11 and the actual steering angle depicted by a solid line L12. In this manner, the difference between the target vehicle swept path and the actual vehicle swept path can also be determined based on a difference between the target steering angle and the actual steering angle.

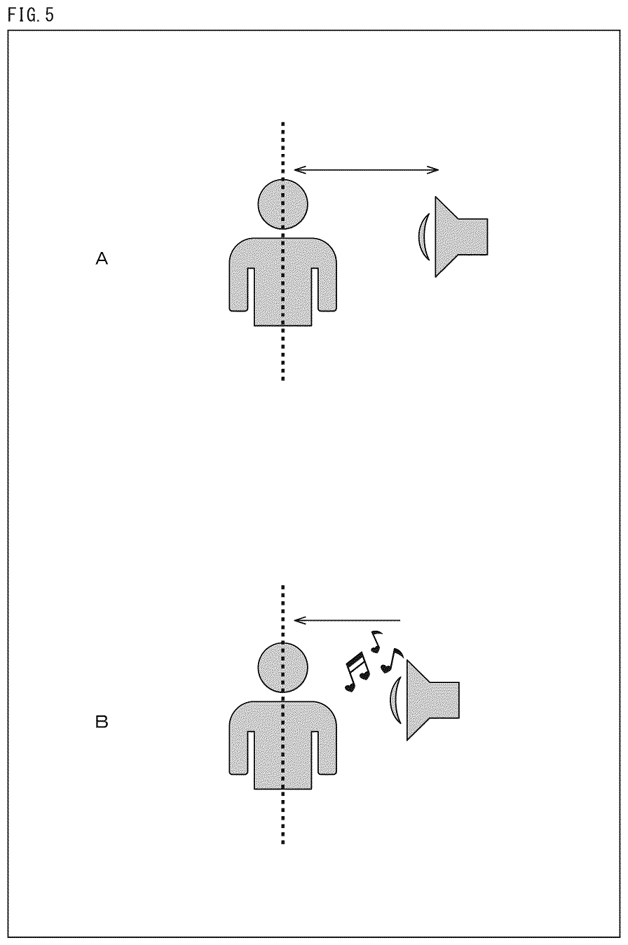

FIG. 5 is a diagram showing an example of a presentation method of a pseudo powertrain sound.

A in FIG. 5 represents a presentation method when the sound source position is adjusted using a direction (left-right direction) and a distance according to a difference in the lateral direction between the target vehicle swept path and the actual vehicle swept path.

B in FIG. 5 represents a presentation method when changing a scale of the pseudo powertrain sound according to a difference between the target vehicle swept path and the actual vehicle swept path. For example, the scale of the pseudo powertrain sound changes by changing frequencies. A change in the pseudo powertrain sound may be realized by performing predetermined signal processing such as applying effects.

In the present example, the sound source position is changed according to the difference between the target vehicle swept path and the actual vehicle swept path and the pseudo powertrain sound is outputted by changing the scale. For example, the larger the difference between the target vehicle swept path and the actual vehicle swept path, the more the pseudo powertrain sound that gives the impression of a disharmonious sound is outputted, and the smaller the difference between the target vehicle swept path and the actual vehicle swept path, the more the pseudo powertrain sound that gives the impression of a harmonious sound is outputted. Sound with predetermined frequencies are respectively used as the pseudo powertrain sound that gives the impression of a disharmonious sound and the pseudo powertrain sound that gives the impression of a harmonious sound.

The presentation of the pseudo powertrain sound of which the scale changes according to the difference between the target vehicle swept path and the actual vehicle swept path is realized using, for example, a plurality of sound sources.

Hereinafter, a case where two sounds with respectively different frequencies are presented from two sound sources will be described. In this case, the pseudo powertrain sound is constituted of two sounds with different frequencies. For example, a sound in a low-frequency range and a sound in a high-frequency range are prepared as sounds that constitute the pseudo powertrain sound.

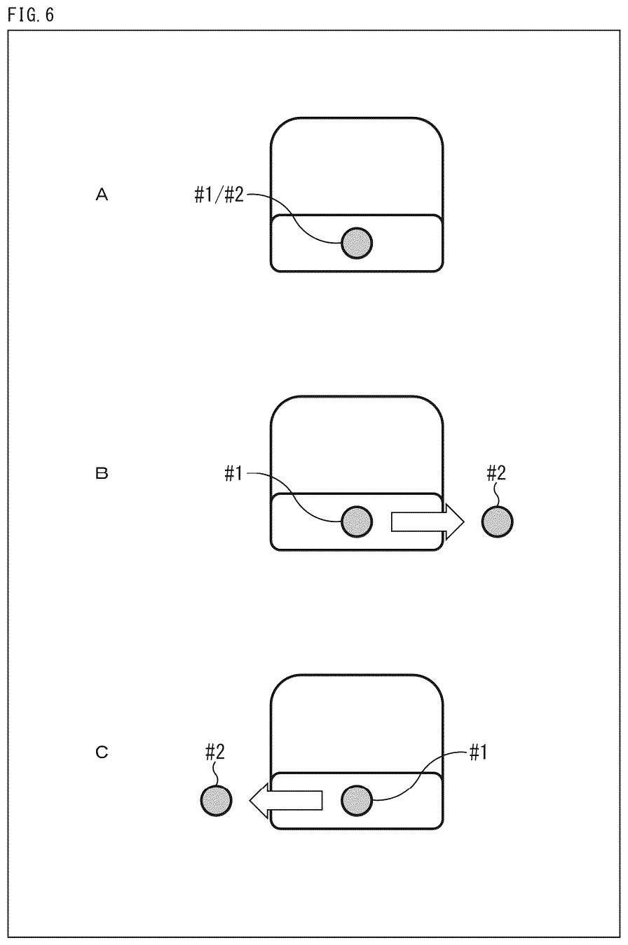

FIG. 6 is a diagram showing an example of adjustment of the sound source position. FIG. 6 shows an example of adjustment of a sound source position using the position of the driver's seat as a reference position.

When traveling along the same vehicle swept path as the target vehicle swept path, as shown in A in FIG. 6, a sound source #1 and a sound source #2 are set to the reference position. The sound source #1 is, for example, a sound source of a sound in the low-frequency range that constitutes the pseudo powertrain sound. The sound source #2 is, for example, a sound source of a sound in the high-frequency range that constitutes the pseudo powertrain sound.

When the actual vehicle swept path is deviated to the left with respect to the target vehicle swept path, as shown in B in FIG. 6, the position of the sound source #1 is fixed and the position of the sound source #2 is set at a position moved to the right from the reference position.

Conversely, when the actual vehicle swept path is deviated to the right with respect to the target vehicle swept path, as shown in C in FIG. 6, the position of the sound source #1 is fixed and the position of the sound source #2 is set at a position moved to the left from the reference position.

The presentation of the pseudo powertrain sound that gives the impression of a harmonious sound/disharmonious sound is realized using the sound source #1 and the sound source #2 of which positions change as described above.

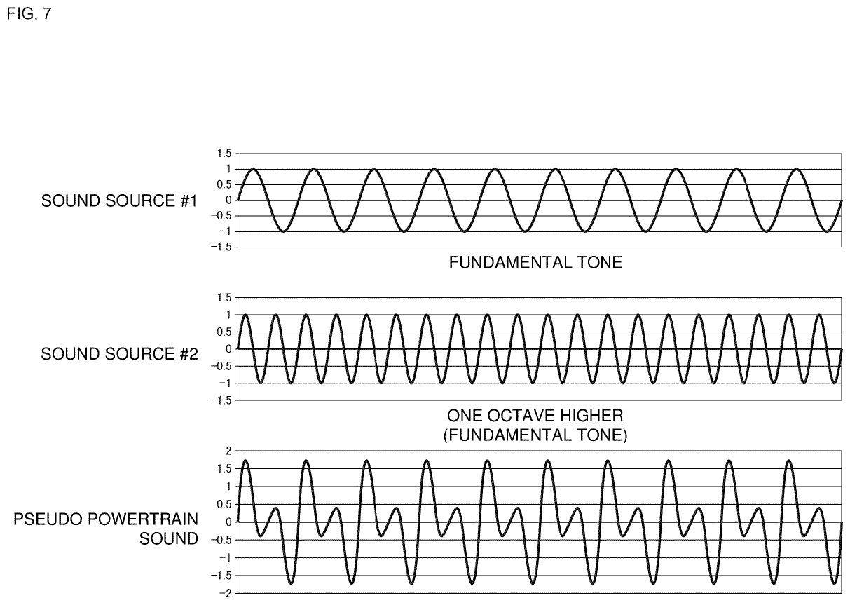

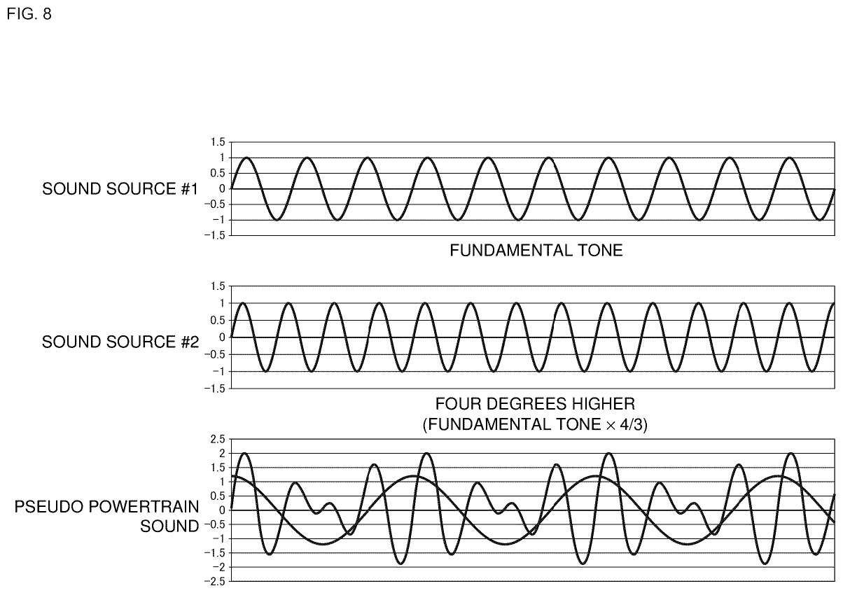

FIGS. 7 and 8 are diagrams showing an example of a change in sounds that constitute the pseudo powertrain sound.

For example, when the vehicle 1 is traveling on a same vehicle swept path as the target vehicle swept path and the sound source #1 and the sound source #2 are set at the reference position (A in FIG. 6), the pseudo powertrain sound that gives the impression of a harmonious sound is outputted as shown in FIG. 7. Using the sound outputted from the sound source #1 as a fundamental tone, for example, a sound one octave higher is outputted from the sound source #2.

In addition, when the vehicle 1 is traveling on a vehicle swept path deviated from the target vehicle swept path and the sound source #2 is set at a position deviated from the reference position (B and C in FIG. 6), the pseudo powertrain sound that gives the impression of a disharmonious sound is outputted as shown in FIG. 8. Using the sound outputted from the sound source #1 as a fundamental tone, for example, a sound four degrees higher is outputted from the sound source #2.

The frequency of the sound outputted from the sound source #2 changes according to an amount of movement of the sound source position. The greater the amount of movement of the sound source position, the more sound is outputted from the sound source #2 that has a frequency that does not resonate when synthesized with the sound of the sound source #1. A parameter indicating a frequency according to the amount of movement of the sound source position is set in advance to be used to adjust the sound outputted from the sound source #2.

Accordingly, different sounds can be outputted from two locations, namely, the driver's seat position that is the reference position and a position in the direction of the target vehicle swept path, thereby enabling presentation of a pseudo powertrain sound that more closely resembles a harmonious sound the closer to the sound source position. In addition to the sound source position, the driver can know whether or not the vehicle 1 is traveling on a same vehicle swept path as the target vehicle swept path according to whether or not the pseudo powertrain sound is a harmonious sound.

The presentation of the pseudo powertrain sound of which the scale changes according to the difference between the target vehicle swept path and the actual vehicle swept path may be realized using one sound source.

In the in-vehicle system, information related to a driving skill of the driver is managed in association with a user account. A range to be a threshold that is used to determine whether or not the vehicle is traveling on the same vehicle swept path as the target vehicle swept path may become narrower as the driver's driving skill improves.

For example, when the difference between the target vehicle swept path and the actual vehicle swept path is within the range of the threshold, it is determined that the vehicle is traveling on the same vehicle swept path as the target vehicle swept path. On the other hand, when the difference between the target vehicle swept path and the actual vehicle swept path exceeds the range of the threshold, it is determined that the vehicle is traveling on a different vehicle swept path from the target vehicle swept path.

Since a narrower range is set as the threshold as the driving skills improve, an allowable range of the target vehicle swept path becomes narrower and more accurate driving is required. This can lead to improvement of the driving skills of the driver. In this manner, the threshold used to determine whether or not to change the sound source position is managed in association with the driver (user). The driver can be given the ability to set threshold information.

### Change in Sound Source Position According to Velocity

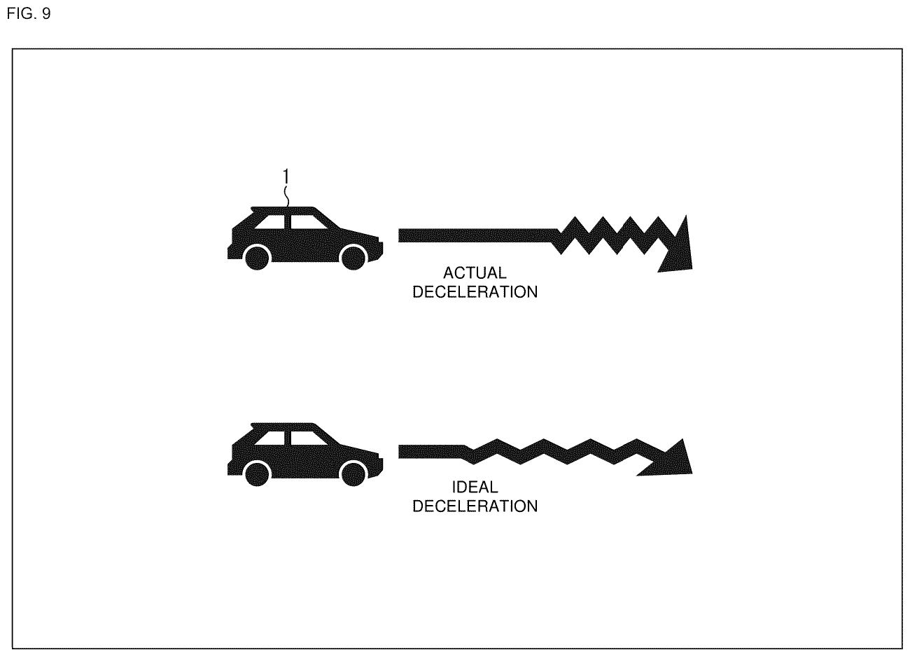

FIG. 9 is a diagram showing an example of deceleration of a vehicle.

In the in-vehicle system mounted to the vehicle 1, a target velocity at each timing including during deceleration and during acceleration is determined according to a travel plan created by the driving automation function. The target velocity is a velocity to be targeted by the vehicle 1. The sound source position of the pseudo powertrain sound is set to a position according to a difference between the target velocity and an actual velocity. An arrow in an upper half of FIG. 9 represents the actual velocity during deceleration and an arrow in a lower half represents the target velocity.

When the actual velocity during deceleration is slower than the target velocity, the sound source position of the pseudo powertrain sound is set so as to be heard from the front. For example, the sound source position is set at a position moved to the front with the position of the driver's seat as the reference position.

Conversely, when the actual velocity during deceleration is faster than the target velocity, the sound source position of the pseudo powertrain sound is set so as to be heard from the back. The sound source position is set at a position moved to the back with the position of the driver's seat as the reference position.

For example, an amount of movement of the sound source position changes according to a difference between the target velocity and the actual velocity. The larger the difference between the target velocity and the actual velocity, the larger the amount of movement of the sound source position from the reference position.

In addition to during deceleration, the sound source position of the pseudo powertrain sound changes in a similar manner during acceleration.

When the actual velocity during acceleration is slower than the target velocity, the sound source position of the pseudo powertrain sound is set so as to be heard from the front. For example, the sound source position is set at a position moved to the front with the position of the driver's seat as the reference position.

Conversely, when the actual velocity during acceleration is faster than the target velocity, the sound source position of the pseudo powertrain sound is set so as to be heard from the back. The sound source position is set at a position moved to the back with the position of the driver's seat as the reference position.

By moving the sound source position of the pseudo powertrain sound in the front-rear direction in this manner, the driver is to hear the pseudo powertrain sound outputted from a position when traveling at the same velocity as the target velocity. The driver can intuitively know the target velocity. In addition, due to a change in the amount of movement of the sound source position, the driver can intuitively know how much the velocity according to the driver's own driving operations relatively deviates from the target velocity.

When traveling at the same velocity as the target velocity, the sound source position of the pseudo powertrain sound is set to the reference position. The driver can intuitively know that he/she is able to travel at the same velocity as the target velocity by confirming that he/she can hear the pseudo powertrain sound from nearby.

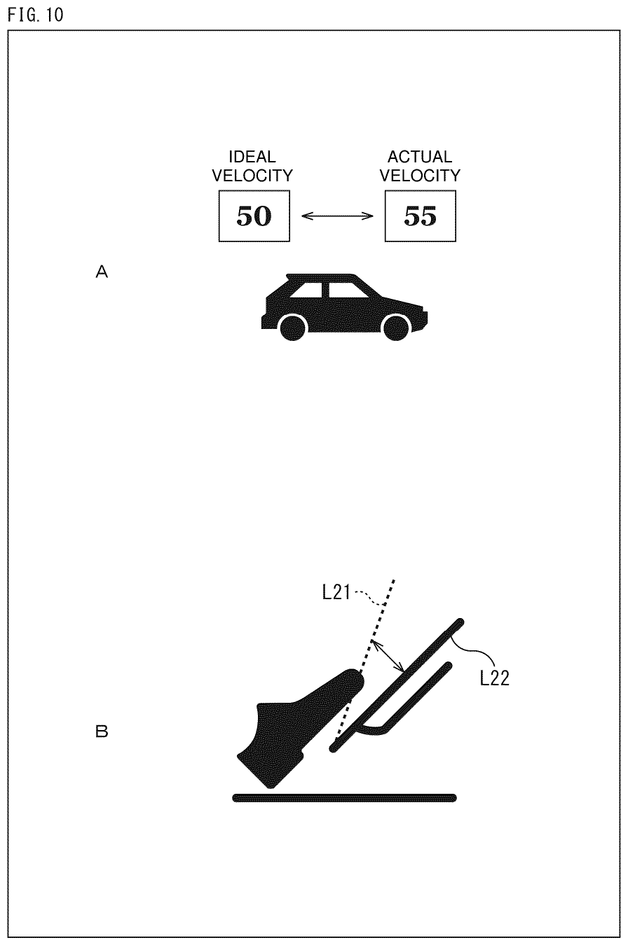

FIG. 10 is a diagram showing an example of a determination method of a deviation of velocity.

The target velocity is set by a travel plan created by the driving automation function. The actual velocity is obtained based on, for example, a result of measurement by a sensor provided at each position in the vehicle 1.

A in FIG. 10 represents a determination method using a target velocity set according to a travel plan created by the driving automation function and an actual velocity obtained based on a measurement result of the sensors. The sound source position of the pseudo powertrain sound is adjusted according to a difference depicted by a two-way arrow between the target velocity and the actual velocity.

B in FIG. 10 represents a determination method using a target angle and an actual angle of a pedal. A determination using an angle of a gas pedal is performed during acceleration and a determination using an angle of a brake pedal is performed during deceleration. The gas pedal and the brake pedal may be constituted of a single pedal. For example, the target angle of the pedal at each timing is determined according to the setting of the target velocity based on the travel plan created by the driving automation function. The sound source position of the pseudo powertrain sound is adjusted according to a difference between the target angle depicted by a dashed line L21 and the actual angle depicted by a solid line L22. In this manner, the sound source position can also be adjusted by determining the difference between the target velocity and the actual velocity based on a difference between the target angle and the actual angle of the pedal.

A presentation method when setting the sound source position using a direction (front-rear direction) and a distance according to the difference between the target velocity and the actual velocity is similar to the presentation method described with reference to FIG. 5. In other words, the scale of the pseudo powertrain sound can also be changed according to a difference between the target velocity and the actual velocity. Repetitive descriptions will be omitted when appropriate.

In the present example, the sound source position is changed according to the difference between the target velocity and the actual velocity and the pseudo powertrain sound is outputted by changing the scale. For example, the larger the difference between the target velocity and the actual velocity, the more the pseudo powertrain sound that gives the impression of a disharmonious sound is outputted, and the smaller the difference between the target velocity and the actual velocity, the more the pseudo powertrain sound that gives the impression of a harmonious sound is outputted.

The presentation of the pseudo powertrain sound of which the scale changes according to the difference between the target velocity and the actual velocity is realized using, for example, a plurality of sound sources. As described with reference to FIGS. 7 and 8, let a sound source #1 denote a sound source of, for example, a sound in the low-frequency range that constitutes the pseudo powertrain sound and a sound source #2 denote a sound source of, for example, a sound in the high-frequency range that constitutes the pseudo powertrain sound.

When traveling at the same velocity as the target velocity, the sound source #1 and the sound source #2 are set to the reference position. In this case, the pseudo powertrain sound presented to the driver is a sound that gives the impression of a harmonious sound. Using the sound outputted from the sound source #1 as a fundamental tone, for example, a sound one octave higher is outputted from the sound source #2.

When the actual velocity is slower than the target velocity, the position of the sound source #1 is fixed and the position of the sound source #2 is set at a position moved to the front from the reference position. Conversely, when the actual velocity is faster than the target velocity, the position of the sound source #1 is fixed and the position of the sound source #2 is set at a position moved to the back from the reference position. In this case, the pseudo powertrain sound presented to the driver is a sound that gives the impression of a disharmonious sound. Using the sound outputted from the sound source #1 as a fundamental tone, for example, a sound four degrees higher is outputted from the sound source #2.

The frequency of the sound outputted from the sound source #2 changes according to an amount of movement of the sound source position. The greater the amount of movement of the sound source position, the more sound is outputted from the sound source #2 that has a frequency that does not resonate when synthesized with the sound of the sound source #1. A parameter indicating a frequency according to the amount of movement of the sound source position is set in advance to be used to adjust the sound outputted from the sound source #2.

Accordingly, different sounds can be outputted from two locations, namely, the driver's seat position that is the reference position and a position according to the target velocity, thereby enabling presentation of a pseudo powertrain sound that more closely resembles a harmonious sound the closer to the sound source position. In addition to the sound source position, the driver can know whether or not the vehicle 1 is traveling at the same velocity as the target velocity according to whether or not the pseudo powertrain sound is a harmonious sound.

The presentation of the pseudo powertrain sound of which the scale changes according to the difference between the target velocity and the actual velocity may be realized using one sound source.

A range to be a threshold that is used to determine whether or not the vehicle is traveling at the same velocity as the target velocity may become narrower as the driver's driving skill improves. For example, when the difference between the target velocity and the actual velocity is within the range of the threshold, it is determined that the vehicle is traveling at the same velocity as the target velocity. On the other hand, when the difference between the target velocity and the actual velocity exceeds the range of the threshold, it is determined that the vehicle is traveling at a velocity that differs from the target velocity.

Since a narrower range is set as the threshold as the driving skills improve, an allowable range of the target velocity becomes narrower and more accurate driving is required. This can lead to improvement of the driving skills of the driver.

### Example of Using Acceleration

Although it has been described that an adjustment of the sound source position is performed according to the velocities during deceleration and during acceleration, an adjustment of the sound source position may be performed according to accelerations during deceleration and during acceleration. In this case, target accelerations during deceleration and during acceleration are determined by a travel plan created by the driving automation function.

During deceleration, the sound source position of the pseudo powertrain sound is set to any position in the front-rear direction according to a difference between a target deceleration and an actual deceleration (an acceleration in a negative direction). For example, when the actual deceleration is greater than the target deceleration, the sound source position is set at a position moved to the front with the position of the driver's seat as the reference position. Conversely, when the actual deceleration is less than the target deceleration, the sound source position is set at a position moved to the back with the position of the driver's seat as the reference position.

During acceleration, the sound source position of the pseudo powertrain sound is set to any position in the front-rear direction according to a difference between a target acceleration and an actual acceleration. For example, when the actual acceleration is less than the target acceleration, the sound source position is set at a position moved to the front with the position of the driver's seat as the reference position. Conversely, when the actual acceleration is greater than the target acceleration, the sound source position is set at a position moved to the back with the position of the driver's seat as the reference position.

### Example of Using Motor Torque

An adjustment of the sound source position may be performed according to motor torques during deceleration and during acceleration. In this case, target torques of the motor during deceleration and during acceleration are determined by a travel plan created by the driving automation function. The sound source position of the pseudo powertrain sound is set to any position in the front-rear direction according to a difference between the target torque and an actual torque.

During deceleration, the sound source position of the pseudo powertrain sound is set to any position in the front-rear direction according to a difference between the target torque and an actual torque. For example, when the actual torque is greater than the target torque, the sound source position is set at a position moved to the front with the position of the driver's seat as the reference position. Conversely, when the actual torque is less than the target torque, the sound source position is set at a position moved to the back with the position of the driver's seat as the reference position.

During acceleration, the sound source position of the pseudo powertrain sound is set to any position in the front-rear direction according to a difference between the target torque and an actual torque. For example, when the actual torque is less than the target torque, the sound source position is set at a position moved to the front with the position of the driver's seat as the reference position. Conversely, when the actual torque is greater than the target torque, the sound source position is set at a position moved to the back with the position of the driver's seat as the reference position.

In both cases where the sound source position is adjusted according to acceleration during deceleration and during acceleration and where the sound source position is adjusted according to motor torque, the pseudo powertrain sound may be outputted by changing the scale in a similar manner to the cases described earlier.

### Change in Sound Source Position According to Acceleration

The sound source position of the pseudo powertrain sound can also be adjusted according to acceleration during travel. The acceleration in this case refers to acceleration with respect to the standard acceleration of gravity. In the in-vehicle system, a magnitude and a direction of acceleration is obtained based on a measurement result of a sensor or the like to be used for the adjustment of the sound source position. A travel state used to adjust the sound source position includes acceleration during travel.

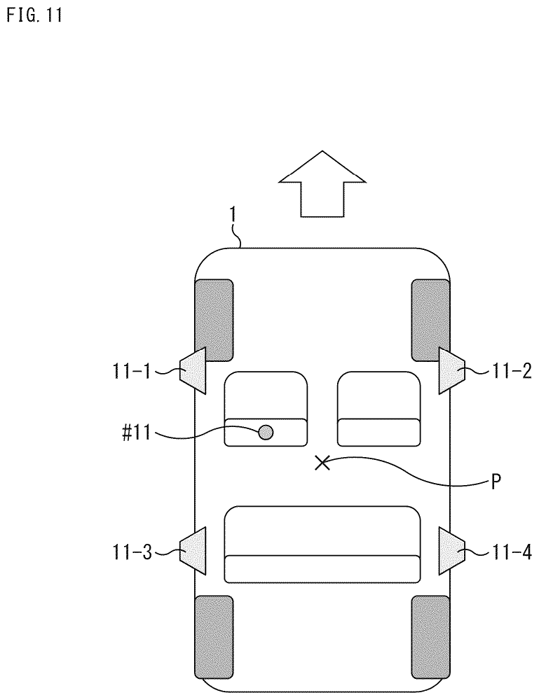

FIG. 11 is a diagram showing an example of a sound source position. Upward in the drawing as indicated by an outline arrow represents the front of the vehicle 1.

As shown in FIG. 11, a sound source #11 is set at the position of the driver's seat that is the reference position. When acceleration is generated during travel, the position of the sound source #11 is moved.

In the example shown in FIG. 11, speakers 11-1 to 11-4 are provided at positions that are diagonally forward left, diagonally forward right, diagonally backward left, and diagonally backward right, respectively, of a position P that is a center of the vehicle 1. A movement of the sound source #11 set at the position of the driver's seat is realized by adjusting volumes of sound outputted from the speakers 11-1 to 11-4 and the like.

For example, when a forward acceleration (forward G) is being generated during deceleration, the position of the sound source #11 is set to a position having been moved to the front from the reference position.

Conversely, when a backward acceleration (backward G) is being generated during acceleration, the position of the sound source #11 is set to a position having been moved to the back from the reference position.

The same is true when the sound source position is moved in the lateral direction. Specifically, a leftward acceleration (lateral G to the left) is generated when turning right and a rightward acceleration is generated when turning left. When a leftward acceleration is being generated during a right turn, the position of the sound source #11 is set to a position having been moved to the left from the reference position.

When a rightward acceleration (lateral G to the right) is being generated during a left turn, the position of the sound source #11 is set to a position having been moved to the right from the reference position.

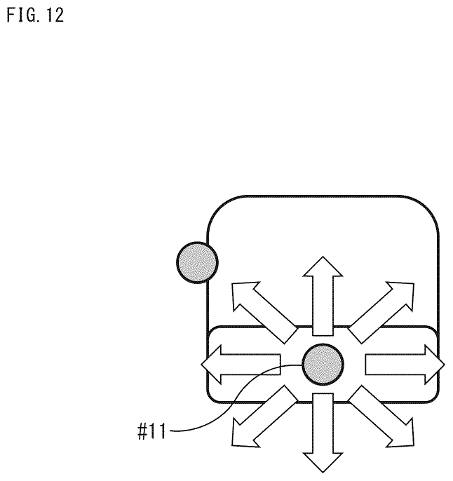

The adjustment of the sound source position in the front-rear direction and the adjustment of the sound source position in the lateral direction as described above are used in combination. Accordingly, as shown in FIG. 12, the sound source position is to move in each direction centered on the position of the driver's seat. As the sound source position moves in response to acceleration, a so-called G-bowl function that indicates the direction of acceleration centered on the driver's seat position is realized using the pseudo powertrain sound. The driver can intuitively know the behavior of the vehicle 1.

Instead of the sound source position moving in the same direction as the direction of acceleration, the sound source position may move in the direction opposite to the direction of acceleration. When the magnitude of acceleration exceeds a threshold, an alert sound may be outputted. The alert sound is different in tone from the pseudo powertrain sound. The magnitude of acceleration adopted as the threshold is set by, for example, the driver.

### Change in Sound Source Position Using Control Information of Vehicle Stabilization System

The in-vehicle system is mounted with a vehicle stabilization system that is a system for stabilizing the behavior of the vehicle 1. For example, functions of the vehicle stabilization system include a skid prevention function that is a function of stabilizing an attitude of the vehicle during a turn, an ABS (anti-lock brake system) function that is a function of preventing wheel lock during braking, and a TCS (traction control system) function that is a function of preventing wheelspin during acceleration. The functions of the vehicle stabilization system include various functions of stabilizing the behavior of the vehicle by controlling torque distribution to the wheels, controlling the brakes, and the like.

Adjustment of the sound source position may be performed according to contents of control information used in the vehicle stabilization system. The control information includes at least one of information used to control the motor and information used to control the brakes on each wheel in order to realize the vehicle stabilization system.

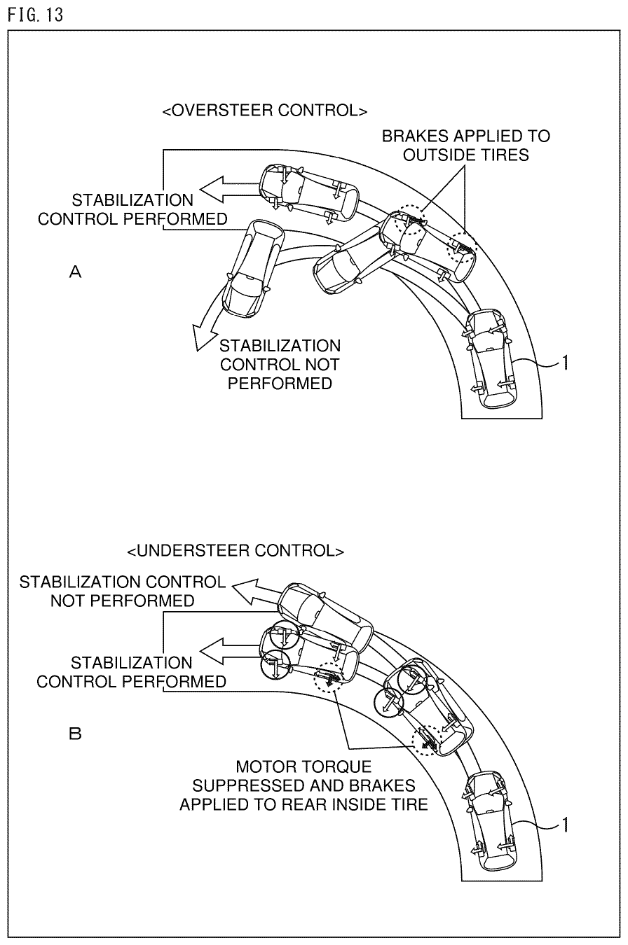

FIG. 13 is a diagram showing an example of vehicle stabilization by the skid prevention function.

A in FIG. 13 represents control during suppression of an oversteer. Control during suppression of an oversteer is performed by, for example, controlling the brakes of outer wheels. Such control prevents the vehicle from turning due to rear wheel slip which can be caused by steering too sharply or the like.

B in FIG. 13 represents control during suppression of an understeer. Control during suppression of an understeer is performed by, for example, controlling torque of the motor and controlling the brake of the rear inner wheel. Such control prevents the vehicle from deviating from the vehicle swept path due to slip of the drive wheels which can be caused by over-stepping on the gas pedal during acceleration in a turn or the like.

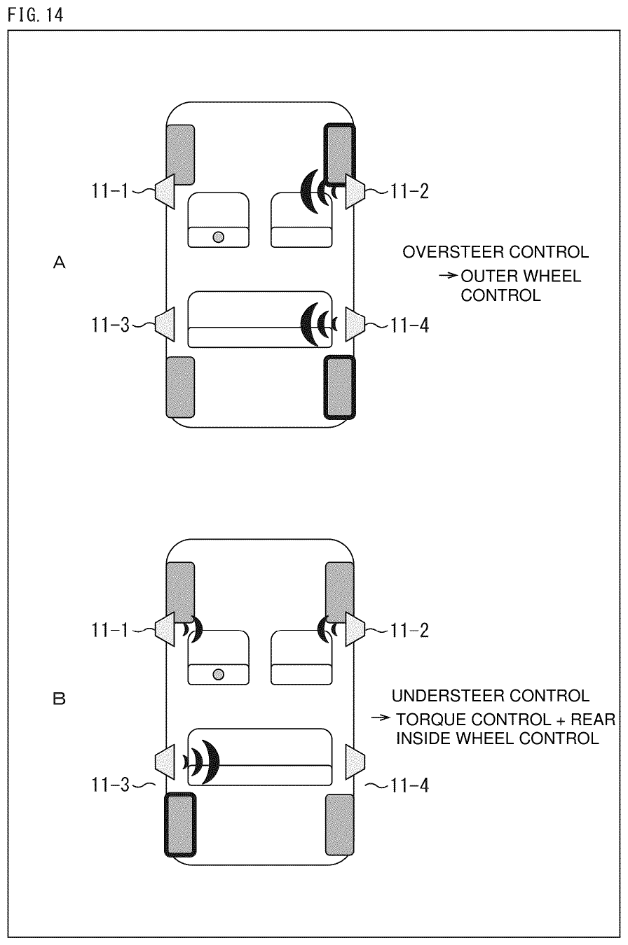

FIG. 14 is a diagram showing an example of adjustment of a sound source position.

When an oversteer occurs during a left turn and control for suppressing the oversteer is performed, as shown in A in FIG. 14, the sound source position is set so that the pseudo powertrain sound is heard from the directions of the right front wheel and the right rear wheel which are outer wheels. In this example, when there are a plurality of wheels that are control objects, a sound source is set in the direction of each of the wheels.

In a similar manner, when an oversteer occurs during a right turn and control for suppressing the oversteer is performed, the sound source position is set so that the pseudo powertrain sound is heard from the directions of the left front wheel and the left rear wheel which are outer wheels.

In this manner, when control for suppressing an oversteer is performed, the sound source position is set so that the pseudo powertrain sound is heard from the direction of each of the wheels that are control objects. The sound source position at the reference position is moved in the direction of each of the wheels that are control objects and the pseudo powertrain sound is outputted from the position after the movement.

Although it has been described that, when there are a plurality of wheels that are control objects, a sound source is set in the direction of each of the wheels, one sound source may be set in the direction of an outer wheel. In this case, the sound source at the position of the driver's seat moves in the direction of the outer wheel before the occurrence of the oversteer and the pseudo powertrain sound is to be heard from near the outer wheel that is the control object.

When an understeer occurs during a left turn and control for suppressing the understeer is performed, as shown in B in FIG. 14, the sound source position is set so that the pseudo powertrain sound is heard from the directions of the left front wheel, the right front wheel, and the left rear wheel. The front wheels are the wheels subjected to suppression of torque and the left rear wheel is the wheel subjected to brake control. Even in this example, when there are a plurality of wheels that are control objects, a sound source is set in the direction of each of the wheels.

In a similar manner, when an understeer occurs during a right turn and control for suppressing the understeer is performed, the sound source position is set so that the pseudo powertrain sound is heard from the directions of the left front wheel, the right front wheel, and the right rear wheel.

In this manner, when control for suppressing an understeer is performed, the sound source position is set so that the pseudo powertrain sound is heard from the direction of each of the wheels that are control objects.

Although it has been described that sound sources are to be set in the directions of the wheels that are control objects of torque and the wheels that are control objects of braking in the present example, the sound source may be set in the directions of either the wheels that are control objects of torque or the wheels that are control objects of braking.

The movement of the sound source position of the pseudo powertrain sound enables the driver to intuitively recognize a state of control by the vehicle stabilization system and can alert the driver to unstable road conditions. In addition, the driver can be made aware of a state of control during sports driving. In other words, appropriate information can be presented to the driver using a pseudo powertrain sound.

The adjustment of the sound source position described above may be performed at a timing where control by the vehicle stabilization system is predicted to intervene, rather than at a timing where control by the vehicle stabilization system is actually exerted.

For example, control by the vehicle stabilization system is predicted by specifying a travel environment such as the road conditions based on measurement result of sensors.

### Configuration Example of In-Vehicle System

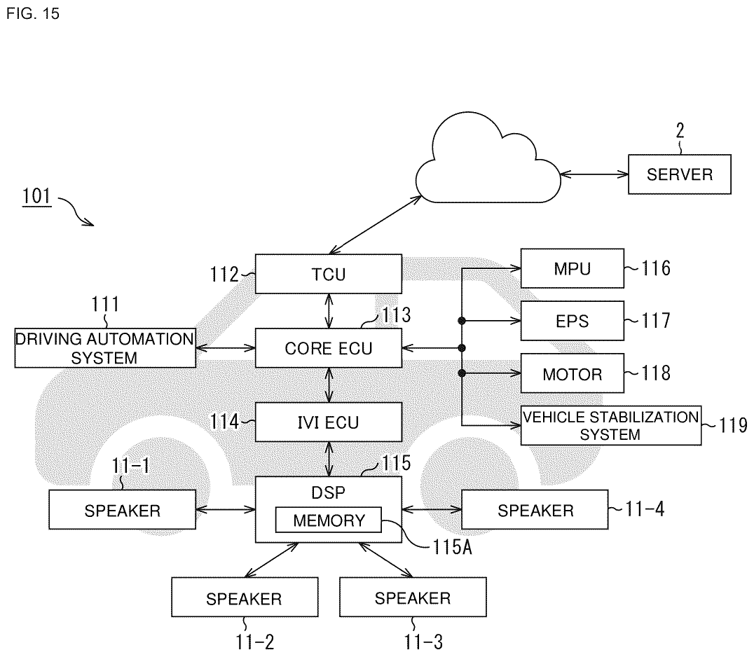

FIG. 15 is a block diagram showing a configuration example of an in-vehicle system 101 to be mounted to the vehicle 1. Same components as described above are denoted by same reference signs. Repetitive descriptions will be omitted when appropriate.

The in-vehicle system 101 is configured to include a driving automation system 111, a TCU 112, a CORE ECU 113, an IVI ECU 114, a DSP 115, an MPU 116, an EPS 117, a motor 118, and a vehicle stabilization system 119. The driving automation system 111, the TCU 112, the CORE ECU 113, the IVI ECU 114, the DSP 115, and the vehicle stabilization system 119 are computers that include a processor as a processing circuit such as a central processing unit (CPU) or a micro processing unit (MPU). The functions of each unit are realized when a prescribed program is executed by the processing circuits.

The driving automation system 111 performs various kinds of processing related to driving automation functions. For example, processing related to the driving automation functions include processing of recognizing a situation of the vehicle 1 and surroundings based on measurement results by the sensors including a camera and processing of generating map information and estimating the vehicle's own position based on measurement results by the sensors. In addition, processing related to the driving automation functions include processing of creating a travel plan from start to goal using map information or the like and processing of controlling operations of the vehicle 1 in order to realize the travel plan.

As control for realizing the travel plan, steering control, brake control, acceleration/deceleration control, direction control, and the like are performed. In addition, control for realizing functions of ADAS such as collision avoidance, crash mitigation, follow-up driving, cruise control, collision warning, and lane departure warning is performed by the driving automation system 111.

The TCU (telematics control unit) 112 communicates among various devices inside and outside the vehicle, other vehicles, servers, base stations, and the like. 5G communication (5th generation mobile communication system), LTE (Long Term Evolution), wireless LAN, or the like is used for communication by the TCU 112. In the example shown in FIG. 15, a server 2 that is a server on the Internet is provided. For example, programs transmitted from the server 2 are received by the TCU 112 and supplied to each unit. The programs received by the TCU 112 include a program that realizes output control of the pseudo powertrain sound.

The CORE ECU 113 is an ECU (electronic control unit) that controls operations of the entire in-vehicle system 101.

THE IVI ECU 114 is an ECU for IVI (in-vehicle infotainment). The IVI ECU 114 controls input of instructions by the driver and presentation of various kinds of information to the driver. The IVI ECU 114 controls display on a display provided in front of the driver's seat or the like.

The DSP 115 controls output of sound from speakers provided inside and outside of the vehicle. Voice guidance for the driver, alert sounds, music, and the like are output from the speakers. The DSP 115 outputs the pseudo powertrain sound from the speakers 11-1 to 11-4.

The DSP 115 includes a memory 115A. The memory 115A stores the program that realizes output control of the pseudo powertrain sound. The memory 115A includes a function as a program storage medium. The memory 115A stores various kinds of data such as audio data of the pseudo powertrain sound.

The MPU 116 controls travel according to driving operations by the driver. In addition, the MPU 116 controls travel according to an action plan created by the driving automation system 111. Drive of the motor 118, the brakes, and the like are controlled by the MPU 116.

The EPS (electric power steering) 117 assists steering operations by the driver.

The motor 118 rotates the wheels according to control by the MPU 116.

The vehicle stabilization system 119 realizes functions of the vehicle stabilization system such as a skid prevention function. The vehicle stabilization system 119 outputs control information to the control units of the motor 118 and the brake of each wheel and performs processing related to functions of the vehicle stabilization system.

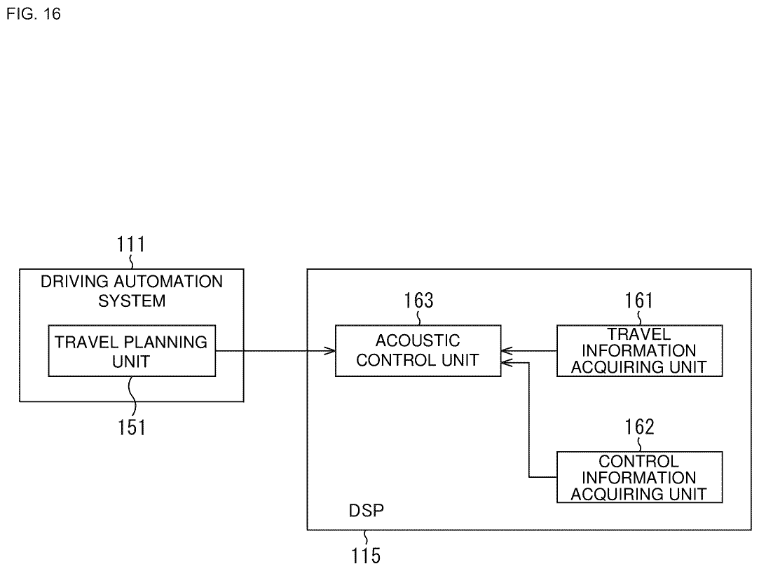

FIG. 16 is a block diagram showing a functional configuration example of the in-vehicle system 101. FIG. 16 shows a configuration related to output control of the pseudo powertrain sound.

The driving automation system 111 includes a travel planning unit 151. The DSP 115 includes a travel information acquiring unit 161, a control information acquiring unit 162, and an acoustic control unit 163. For example, in the DSP 115, the travel information acquiring unit 161, the control information acquiring unit 162, and the acoustic control unit 163 are executed when a program stored in the memory 115A is executed.

The travel planning unit 151 of the driving automation system 111 performs travel planning using map information and the like. A travel state to be a target at each timing such as a target vehicle swept path, a target velocity during deceleration and acceleration, and a target acceleration are represented by the travel plan. Travel planning by the travel planning unit 151 corresponds to planning a travel state at each timing. Information on the travel plan is outputted from the travel planning unit 151 and supplied to the DSP 115 via the CORE ECU 113 and the IVI ECU 114.

The travel information acquiring unit 161 of the DSP 115 acquires travel information generated based on a measurement result by the sensors and the like. Travel information indicating a travel state of the vehicle 1 is generated by the CORE ECU 113 and the like to be used in processing of the various units. Travel information to be used in the processing of the various units is supplied to the DSP 115 and acquired by the travel information acquiring unit 161.

The travel information acquired by the travel information acquiring unit 161 represents an actual vehicle swept path, an actual velocity during deceleration and acceleration, an actual acceleration, a steering angle of the steering wheel, an angle of a pedal, and an acceleration (G) generated in the vehicle 1. At least one of these pieces of information may be represented by the travel information. The travel information acquired by the travel information acquiring unit 161 is supplied to the acoustic control unit 163.

The control information acquiring unit 162 acquires control information generated by the vehicle stabilization system 119 and used to control the motor and the brake of each wheel. The control information represents wheels that have become control objects due to the functions of the vehicle stabilization system. The control information acquired by the control information acquiring unit 162 is supplied to the acoustic control unit 163.

The acoustic control unit 163 controls, based on information supplied from each unit, output of the pseudo powertrain sound to be outputted in the vehicle. For example, the acoustic control unit 163 sets a sound source position at any position in the vehicle and performs rendering processing of audio data according to the sound source position. The acoustic control unit 163 outputs an audio signal generated by the rendering processing to each speaker and causes the speaker to output the pseudo powertrain sound.

The acoustic control unit 163 specifies a planned travel state based on the information supplied from the travel planning unit 151. With the planned travel state as a target travel state, the acoustic control unit 163 changes the sound source position of the pseudo powertrain sound according to a difference between the target travel state and an actual travel state represented by the travel information supplied from the travel information acquiring unit 161.

As the difference between the target travel state and the actual travel state, the difference in the lateral direction between the target vehicle swept path and the actual vehicle swept path, the difference between the target velocity and the actual velocity, the difference between the target acceleration and the actual acceleration, the difference between the target steering angle and the actual steering angle of the steering wheel, and the difference between the target angle and the actual angle of the pedal are obtained and used for the adjustment of the sound source position.

In addition, the acoustic control unit 163 changes the sound source position of the pseudo powertrain sound according to a direction and a magnitude of the acceleration represented by the travel information supplied from the travel information acquiring unit 161. The acoustic control unit 163 also performs processing of changing a frequency of at least a part of the sounds that constitute the pseudo powertrain sound to change a scale of the sounds, processing of managing information of thresholds set by the user, and the like.

The acoustic control unit 163 specifies wheels that have become control objects due to the vehicle stabilization system based on the control information supplied from the control information acquiring unit 162. The acoustic control unit 163 sets a sound source at any position in the direction of the wheel that has become a control object and causes the sound source to output the pseudo powertrain sound. The acoustic control unit 163 performs processing of changing the sound source position of the pseudo powertrain sound according to the control information with respect to each wheel.

### Operation of In-Vehicle System

### Processing of Entire System

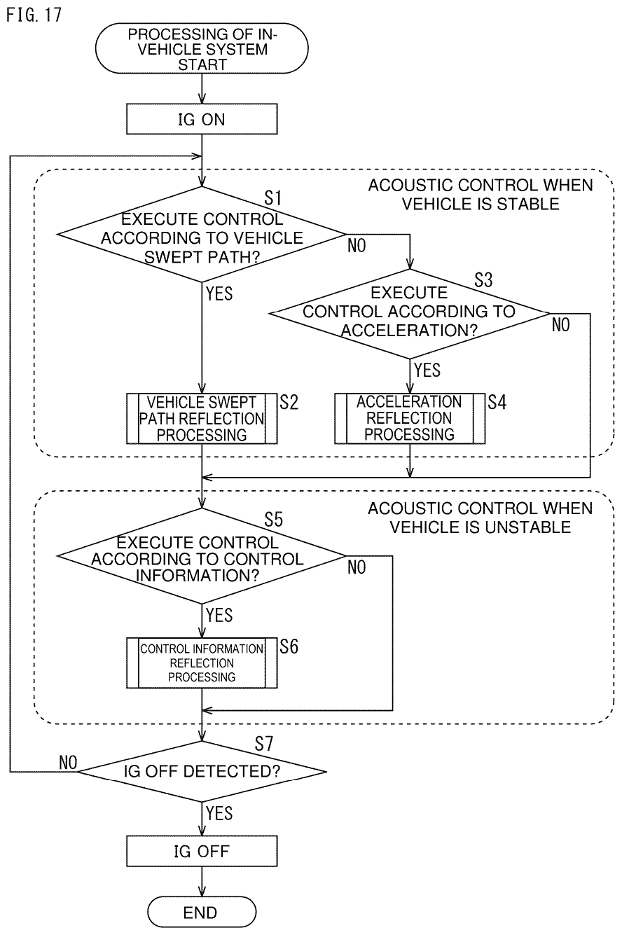

FIG. 17 is a flow chart showing an example of processing of the entire in-vehicle system 101 configured as described above. The processing shown in FIG. 17 is started when an operation to turn on the ignition is performed and the in-vehicle system 101 is activated. The output of the pseudo powertrain sound is started when the in-vehicle system 101 is activated.

In step S1, the acoustic control unit 163 determines whether or not to perform control of the sound source position according to the vehicle swept path.

When it is determined in step S1 that control of the sound source position according to the vehicle swept path is to be performed, in step S2, the acoustic control unit 163 performs vehicle swept path reflection processing. The vehicle swept path reflection processing is processing including changing the sound source position of the pseudo powertrain sound according to the difference between the target vehicle swept path and the actual vehicle swept path.

On the other hand, when it is determined in step S1 that control of the sound source position according to the vehicle swept path is not to be performed, in step S3, the acoustic control unit 163 determines whether or not to perform control of the sound source position according to acceleration.

When it is determined in step S3 that control of the sound source position according to acceleration is to be performed, in step S4, the acoustic control unit 163 performs acceleration reflection processing. The acceleration reflection processing is processing including changing the sound source position of the pseudo powertrain sound according to the acceleration.

When it is determined in step S3 that control of the sound source position according to acceleration is not to be performed, the processing advances to step S5.

Similarly, the processing advances to step S5 after vehicle swept path reflection processing is performed in step S2 and after acceleration reflection processing is performed in step S4.

Processing of steps S1 to S4 enclosed by a dashed line in FIG. 17 is processing performed when travel of the vehicle 1 is stable.

In step S5, the acoustic control unit 163 determines whether or not to perform control of the sound source position according to the control information outputted by the vehicle stabilization system 119. For example, when control information is outputted from the vehicle stabilization system 119 with respect to control mechanisms of the motor 118 and the brakes, it is determined that control of the sound source position according to control information is to be performed.

When it is determined in step S5 that control of the sound source position according to the control information is to be performed, in step S6, the acoustic control unit 163 performs control information reflection processing. The control information reflection processing is processing of changing the sound source position of the pseudo powertrain sound according to the control information.

After the control information reflection processing is performed in step S6 or when it is determined in step S5 that control of the sound source position according to the control information is not to be performed, the processing advances to step S7.

Performing control by the vehicle stabilization system 119 means that a skid or the like has occurred and the travel state of the vehicle 1 is not stable. Processing of steps S5 and S6 enclosed by a dashed line in FIG. 17 is processing performed when travel of the vehicle 1 is unstable.

In step S7, the CORE ECU 113 determines whether or not an operation to turn off the ignition is detected. Processing of step S1 and subsequent steps is repeatedly executed until it is determined in step S7 that an operation to turn off the ignition is detected. The processing of FIG. 17 ends when an operation to turn off the ignition is performed.

### Vehicle Swept Path Reflection Processing

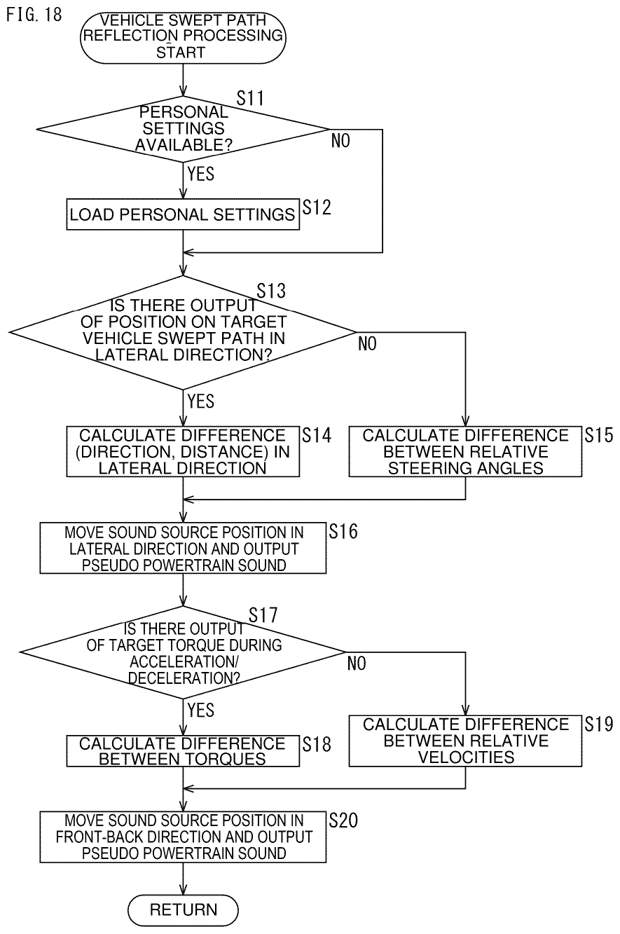

FIG. 18 is a diagram showing an example of vehicle swept path reflection processing that is performed in step S2 in FIG. 17.

In step S11, the acoustic control unit 163 determines whether or not personal settings related to control of the pseudo powertrain sound are available. Personal settings include a threshold used to determine whether or not the sound source position is to be changed. Information on the personal settings is stored in, for example, the memory 115A in association with a user account.

When it is determined in step S11 that personal settings are available, in step S12, the acoustic control unit 163 reads the personal settings. When it is determined in step S11 that personal settings are not available, the processing of step S12 is skipped. In this case, for example, default settings are used in the processing.

In step S13, the acoustic control unit 163 determines whether or not output of information regarding a position in the lateral direction on the target vehicle swept path is available. When travel is being performed according to the travel plan created by the travel planning unit 151, information regarding the position in the lateral direction on the target vehicle swept path with the position of the vehicle 1 as a reference may be outputted from the driving automation system 111.

When it is determined in step S13 that output of information regarding a position in the lateral direction on the target vehicle swept path is available, in step S14, the acoustic control unit 163 specifies an actual position in a driving lane based on a measurement result of sensors. The acoustic control unit 163 calculates a difference between the target vehicle swept path and the actual vehicle swept path in the lateral direction by comparing a position in the lateral direction on the target vehicle swept path and an actual position.

On the other hand, when it is determined in step S13 that output of information regarding a position in the lateral direction on the target vehicle swept path is not available, in step S15, the acoustic control unit 163 specifies an actual steering angle of the steering wheel based on a measurement result of sensors. The acoustic control unit 163 compares the target steering angle and the actual steering angle with each other to calculate a relative difference between the steering angles.

In step S16, the acoustic control unit 163 moves the sound source position in the lateral direction according to the difference calculated in step S14 or S15 and outputs the pseudo powertrain sound.

In step S17, the acoustic control unit 163 determines whether or not output of information regarding a target torque during acceleration and deceleration is available. When travel is being performed according to the travel plan created by the travel planning unit 151, information regarding the target torque during acceleration and deceleration may be outputted from the driving automation system 111.

When it is determined in step S17 that output of information regarding the target torque during acceleration and deceleration is available, in step S18, the acoustic control unit 163 specifies an actual torque of the motor 118 based on a measurement result of sensors. The acoustic control unit 163 compares the target torque and the actual torque of the motor 118 with each other to calculate a relative difference between the torques.

On the other hand, when it is determined in step S17 that output of information regarding the target torque is not available, in step S19, the acoustic control unit 163 specifies an actual velocity of the vehicle 1 based on a measurement result of sensors. The acoustic control unit 163 compares the target velocity and the actual velocity with each other to calculate a relative difference between the velocities.

In step S20, the acoustic control unit 163 moves the sound source position in the front-rear direction according to the difference calculated in step S18 or S19 and outputs the pseudo powertrain sound. Subsequently, a return is made to step S2 in FIG. 17 and processing of step S2 and subsequent steps is performed.

### Acceleration Reflection Processing

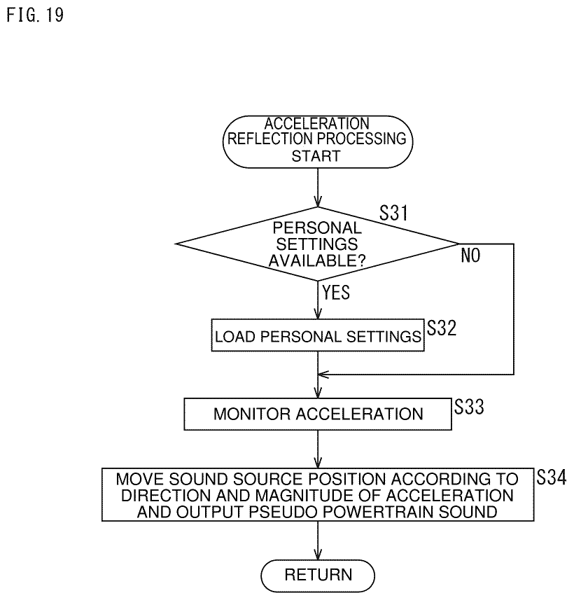

FIG. 19 is a diagram showing an example of acceleration reflection processing that is performed in step S4 in FIG. 17.

In step S31, the acoustic control unit 163 determines whether or not personal settings related to control of the pseudo powertrain sound are available.

When it is determined in step S31 that personal settings are available, in step S32, the acoustic control unit 163 reads the personal settings. When it is determined in step S31 that personal settings are not available, the processing of step S32 is skipped.

In step S33, the acoustic control unit 163 monitors acceleration generated in the vehicle 1 based on a measurement result 41 sensors. Due to the monitoring, a direction and a magnitude of acceleration at each timing are specified.

In step S34, the acoustic control unit 163 moves the sound source position according to the direction and the magnitude of the acceleration and outputs the pseudo powertrain sound. Subsequently, a return is made to step S4 in FIG. 17 and processing of step S4 and subsequent steps is performed.

### Control Information Reflection Processing

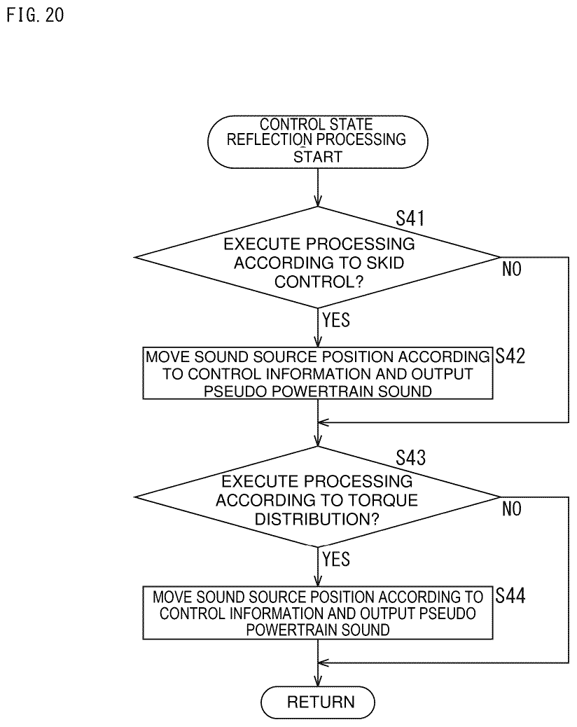

FIG. 20 is a diagram showing an example of control information reflection processing that is performed in step S6 in FIG. 17.

In step S41, the acoustic control unit 163 determines whether or not to perform processing according to skid control. For example, it is determined that processing according to skid control is to be performed when the skid prevention function according to the vehicle stabilization system 119 is activated. A determination that processing according to skid control is to be performed may be made when an occurrence of a skid is predicted based on a measurement result of sensors.

When it is determined in step S41 that processing according to skid control is to be performed, in step S42, the acoustic control unit 163 specifies wheels that have become control objects based on the control information. The acoustic control unit 163 moves the sound source position in a direction of the wheels that have become control objects and outputs the pseudo powertrain sound. When it is determined in step S41 that processing according to skid control is not to be performed, the processing of step S42 is skipped.

In step S43, the acoustic control unit 163 determines whether or not to perform processing according to torque distribution. For example, it is determined that processing according to torque distribution is to be performed when the ABS function or the TCS function of the vehicle stabilization system 119 is activated.

When it is determined in step S43 that processing according to torque distribution is to be performed, in step S44, the acoustic control unit 163 specifies wheels (motor 118) that have become control objects based on the control information. The acoustic control unit 163 moves the sound source position in a direction of the wheels that have become control objects and outputs the pseudo powertrain sound. When it is determined in step S43 that processing according to torque distribution is not to be performed, the processing of step S44 is skipped.

Subsequently, a return is made to step S6 in FIG. 17 and processing of step S6 and subsequent steps is performed.

The series of processing described above enables pseudo engine sounds that can improve the driver's safety awareness and driving skills to be presented.

Information that inform the driver of an ideal travel state can be presented using pseudo powertrain sounds.

In other words, the in-vehicle system 101 can present appropriate information to the driver using pseudo powertrain sounds.

### Modifications

Although the adjustment of the sound source position using the position of the driver's seat as the reference position has been mainly described, other positions may be used as the reference position such as the position of the passenger's seat or the center position of the vehicle 1. The sound source position of the pseudo powertrain sound set to the position of the passenger's seat or the like is to be moved according to a travel state or the like.

When the vehicle 1 has a speaker configuration that can present sound for each seat, the position of each seat may be set as a reference position and the sound source position of the pseudo powertrain sound set to each seat position may be moved according to a travel state or the like.

Audio data used as a reproduction object may be switched according to the sound source position.

The series of processing described above can be executed by hardware or executed by software. When the series of processing is to be executed by software, a program constituting the software is to be installed in a computer. In this case, the term “computer” is to include computers built into dedicated hardware and general-purpose personal computers or the like that enable various functions to be executed by installing various programs.

The program to be executed by the computer (processing circuitry) can be provided recorded on a removable medium as a packaged medium or the like. In addition, the program can be provided via a wired or wireless transmission medium such as a local area network, the Internet, and digital satellite broadcast.

The program to be executed by the computer may be a program that is processed chronologically according to the order described in the present specification or a program that is processed in parallel or at necessary timing such as when a call is made.

The processing performed by the computer according to the program need not necessarily be performed chronologically according to the orders described as flowcharts. In other words, the processing that the computer performs according to the program includes processing that is executed in parallel or individually (for example, parallel processing or object-based processing).

The program may be processed by a single computer (processor) or processed in a distributed manner by a plurality of computers. Furthermore, the program may be transferred to and executed by a remote computer.

In the present specification, a system means a single component or a set of a plurality of components (apparatuses, modules (parts), and the like). Therefore, one or more components of a computer such as a processor on its own or a combination of a processor and a memory constitute a system. With respect to a set of a plurality of components, whether or not all of the components are housed in a same enclosure is irrelevant. Therefore, a plurality of apparatuses housed in separate enclosures and connected via a network, a single apparatus containing a plurality of modules in a single enclosure, and the like all constitute systems.

Furthermore, for example, an entire computer or a combination of a computer and another apparatus such as a server (not illustrated) also constitute a system.

The embodiment of the present technique is not limited to the embodiment described above and various modifications are possible within the scope of the gist of the present technique.

The effects described in the present specification are illustrative only and are not limited, and there may be other effects as well.

### REFERENCE SIGNS LIST

101 in-vehicle system, 111 driving automation system, 115 DSP, 151 travel planning unit, 161 travel information acquiring unit, 162 control information acquiring unit, 163 acoustic control unit.

1. An in-vehicle system, comprising:
an acquiring unit configured to acquire control information used to control each wheel of a vehicle and that represents a wheel to be a control object; and
an acoustic control unit configured to change a sound source position of a pseudo powertrain sound to be outputted in the vehicle according to the control information,
wherein the acoustic control unit is further configured to specify the wheel to be the control object based on the control information, and move the sound source position in a direction of the specified wheel, and
wherein the acquiring unit and the acoustic control unit are each implemented via at least one processor.

2. The in-vehicle system according to claim 1, wherein the acoustic control unit is further configured to change the sound source position according to the control information used to control a brake mechanism of each wheel.

3. (canceled)

4. The in-vehicle system according to claim 1, wherein
when a plurality of the wheels are to be control objects, the acoustic control unit is further configured to move the sound source position in a direction of each wheel of the plurality of wheels to be a control object.

5. The in-vehicle system according to claim 1, wherein
the acquiring unit is further configured to acquire the control information used in control by a vehicle stabilization system, and
the acoustic control unit is further configured to change the sound source position in response to a prediction of intervention of control by the vehicle stabilization system.

6. The in-vehicle system according to claim 1, wherein
the acoustic control unit is further configured to change the sound source position according to the control information used to control a motor that rotates each wheel.

7. A non-transitory computer-readable medium having embodied thereon a program, which when executed a computer causes the computer to execute a processing method, the method comprising:
acquiring control information used to control each wheel of a vehicle and that represents a wheel to be a control object; and
changing a sound source position of a pseudo powertrain sound to be outputted in the vehicle according to the control information,
wherein the changing of the sound source position further includes specifying the wheel to be the control object based on the control information, and moving the sound source position in a direction of the specified wheel.

8. A processing method, the method comprising:
acquiring control information used to control each wheel of a vehicle and that represents a wheel to be a control object; and
changing a sound source position of a pseudo powertrain sound to be outputted in the vehicle according to the control information,
wherein the changing of the sound source position further includes specifying the wheel to be the control object based on the control information, and moving the sound source position in a direction of the specified wheel.
